(19) United States
(12) Patent Application Publication
(10) Pub. No.: US 2013/0292199 A1
(43) Pub. Date: Nov. 7, 2013

(54) Transportation Device and Method Thereof

(71) Applicant: Jeffrey Todd Blanton, (US)

(72) Inventor: Jeffrey Todd Blanton, (US)

(21) Appl. No.: 13/463,512

(22) Filed: May 3, 2012

(51) Int. Cl. B60K 8/00

(52) U.S. Cl. 180/291

(57) ABSTRACT

A transport may include a drive train, a fixed chassis mount on the drive train, and a pedestal assembly between the drive train and the fixed chassis mount. In example embodiments the fixed chassis mount may be configured to rotate on the drive train.

### BACKGROUND

1. Field

The present invention relates to methods and apparatuses for moving large and/or heavy objects. More specifically, the invention relates to a transport configured to manipulate a relatively long object by employing rotationally associated members.

2. Description of the Related Art

Long objects, for example, windmill blades, may be relatively difficult to manipulate. Conventional methods of moving long objects from one location to another employ the use of cranes and dollies. However, conventional apparatuses and methods may impose relatively large stresses in the long object while they are being moved. Furthermore, long objects may be difficult to move in a manufacturing environment where the space is relatively small. Thus, new apparatuses and methods for moving long objects are desired.

### SUMMARY

Example embodiments relate to a transport that includes at least two support frames in which a first support frame is rotatably supported on a second support frame. Example embodiments also relate to a method of moving a relatively large object using the transport.

In accordance with example embodiments, a transport may include a drive train, a fixed chassis mount on the drive train, and a pedestal assembly between the drive train and the fixed chassis mount, wherein the fixed chassis mount is configured to rotate on the drive train. In example embodiments the drive train may include a drive unit configured to move the transport in at least one direction

In accordance with example embodiments a pair of transports may be used to move a relatively long load. For example, when used in pairs, the load may be connected to the fixed chassis mounts of the pair of transports. The load may be translated by simultaneously operating the drive units of each transport and controlling the drive units such that they are driven in the same direction. In the alternative, because the fixed chassis mounts are rotatable with respect to the drive trains, the load may be rotated by activating only one drive unit of the pair of transports. In this latter example, when only the one drive unit of the pair of transports is activated, the load may be rotated about transport whose drive unit is not activated. Thus, the pair of transports may not only translate the load, but may rotate it as well. In addition, because the drive units may be reversible, one drive unit of one of the transports may move the one of the transports in a first direction while the drive unit of the other transport of the pair of transports may drive the other transport in second direction. Thus, the load may be made to rotate about a point between the pair of transports.

In accordance with example embodiments a pair of transports may be used to crab walk a relatively long load. For example, the pair of transports may be comprised of a first transport supporting the load at a first end of the load and a second transport supporting the load at a second end of the load. The first transport may be controlled to be in a stationary position while the second transport is controlled to translate in a first distance in a first direction. The second transport may then be controlled to stop its motion and the first transport may then be controlled to move in the first direction a second distance thus crabwalking the load.

### BRIEF DESCRIPTION OF THE DRAWINGS

Example embodiments are described in detail below with reference to the attached drawing figures, wherein:

FIG. 1 is a perspective view of a transport in accordance with example embodiments;

FIG. 2A is a perspective-section view of a drive train in accordance with example embodiments;

FIG. 2B is a top view of the drive train in accordance with example embodiments;

FIG. 2C is a side view of the drive train in accordance with example embodiments;

FIG. 2D is a perspective view of the drive train in accordance with example embodiments, the drive train having various elements hidden in order to better illustrate various features of the drive train;

FIG. 2E is a perspective view of the drive train in accordance with example embodiments, the drive train having various elements hidden in order to better illustrate various features of the drive train;

FIG. 2F is a view of a first structural member in accordance with example embodiments;

FIG. 2G is a view of a second structural member in accordance with example embodiments;

FIG. 2H is a view of the first structural member with connecting structures attached thereto in accordance with example embodiments;

FIG. 2I is a view of the first structural member with a drive and brake unit attached thereto in accordance with example embodiments;

FIG. 2J is a view of the second structural member with supporting structures attached thereto in accordance with example embodiments;

FIG. 2K is a view of the first structural member with intermediate supports attached thereto in accordance with example embodiments;

FIG. 2L is a view of the second structural member with intermediate supports attached thereto in accordance with example embodiments;

FIG. 2M is a view of the first structural member with intermediate supports and a base attached thereto in accordance with example embodiments;

FIGS. 3A-3F are views of the pedestal assembly in accordance with example embodiments;

FIGS. 4A-C are views of the fixed chassis mount in accordance with example embodiments;

FIG. 5 is an exploded view of the transport in accordance with example embodiments;

FIG. 6A-6B are views of the fixed chassis mount engaging the pedestal assembly in accordance with example embodiments; and

FIG. 7 is a view of a load being moved in a first direction and a second direction in accordance with example embodiments.

### DETAILED DESCRIPTION

Example embodiments will now be described more fully with reference to the accompanying drawings, in which example embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on,” “connected to,” or “coupled to” another element or layer, it can be directly on, connected to, or coupled to the other element or layer or intervening elements or layers that may be present. In contrast, when an element is referred to as being “directly on,” “directly connected to,” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers, and/or sections, these elements, components, regions, layers, and/or sections should not be limited by these terms. These terms are only used to distinguish one element, component, region, layer, and/or section from another elements, component, region, layer, and/or section. Thus, a first element component region, layer or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the structure in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments described herein will refer to plan views and/or cross-sectional views by way of ideal schematic views. Accordingly, the views may be modified depending on manufacturing technologies and/or tolerances. Therefore, example embodiments are not limited to those shown in the views, but include modifications in configurations formed on the basis of manufacturing process. Therefore, regions exemplified in the figures have schematic properties and shapes of regions shown in the figures exemplify specific shapes or regions of elements, and do not limit example embodiments.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments of the invention relate to a transport having rotationally associated elements.

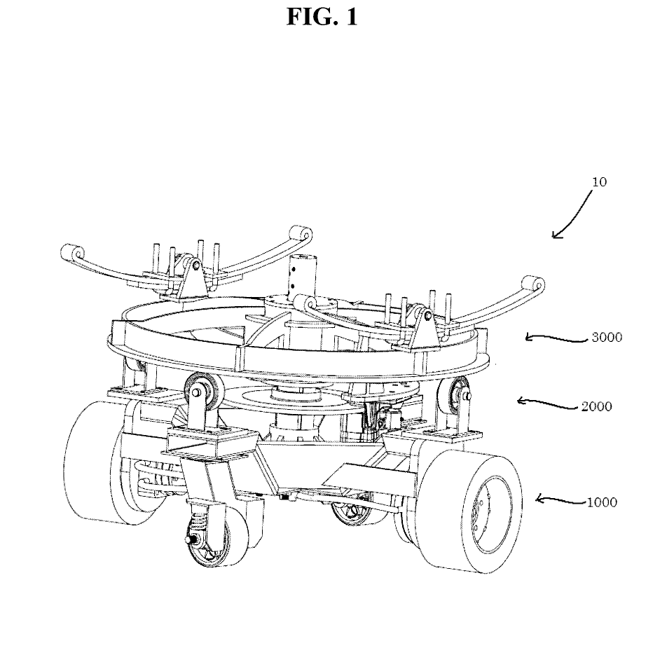

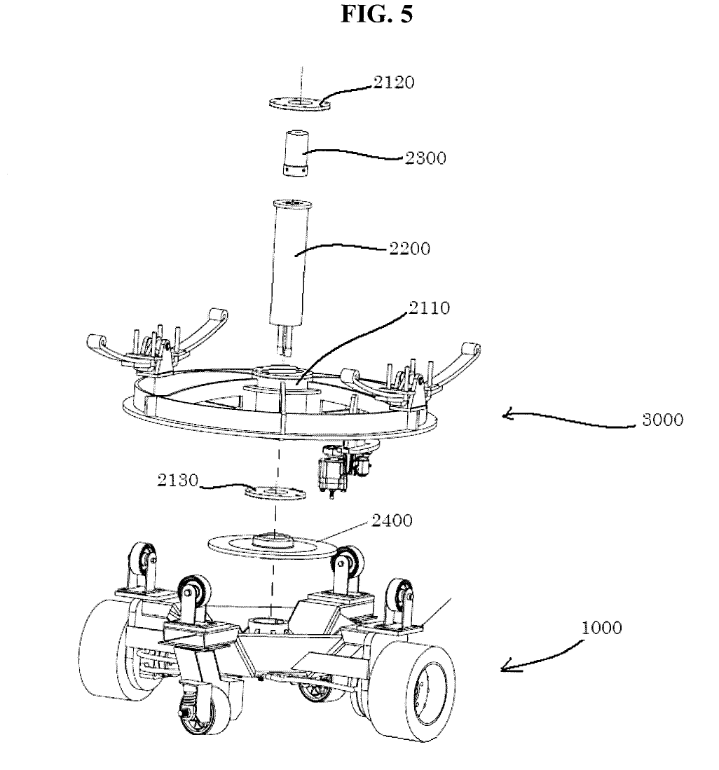

FIG. 1 is a perspective view of a transport 10 in accordance with example embodiments and FIG. 5 is an exploded view thereof. As will be explained shortly, the transport 10 may be used to move a relatively long object, for example, a windmill blade. As shown in FIG. 1, the transport 10 may include a drive train 1000, a pedestal assembly 2000 on the drive train 1000, and a fixed chassis mount 3000 on the pedestal assembly 2000. In the present non-limiting example of the transport 10, the fixed chassis mount 3000 may be supported by the drive train 1000 in a manner that allows the fixed chassis mount 3000 to rotate thereon.

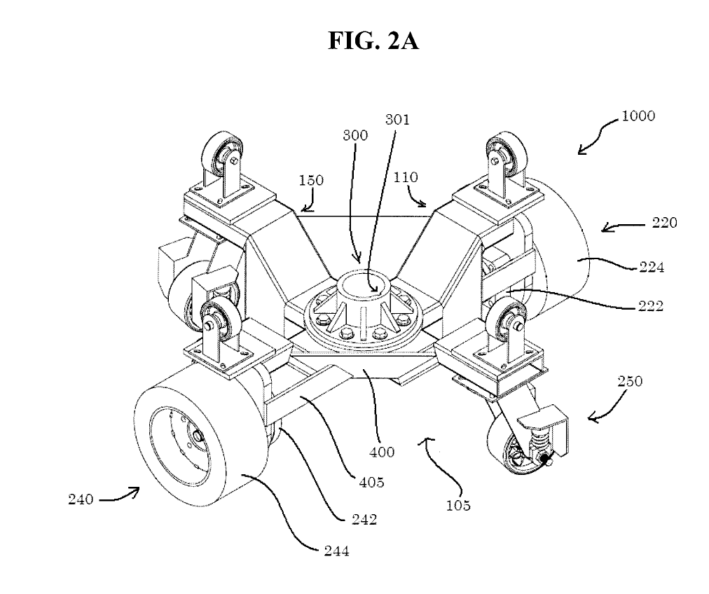

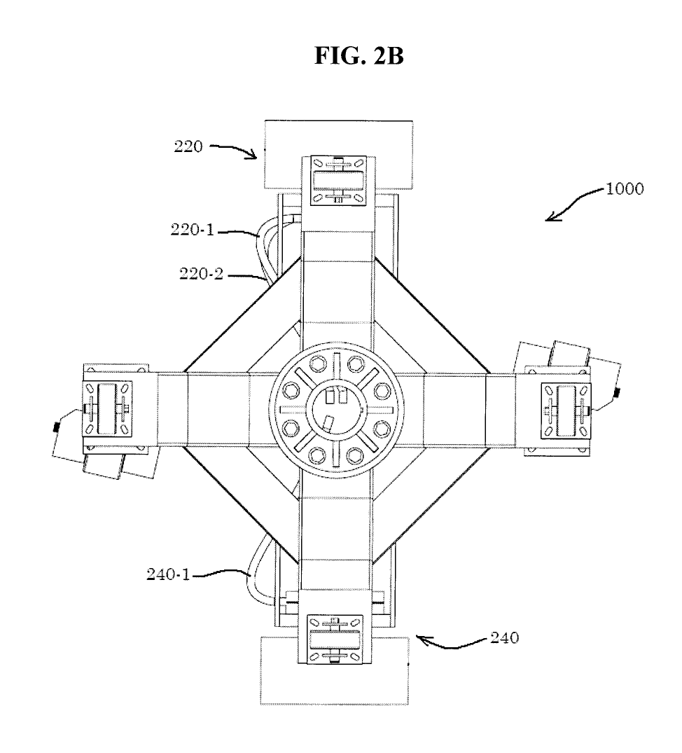

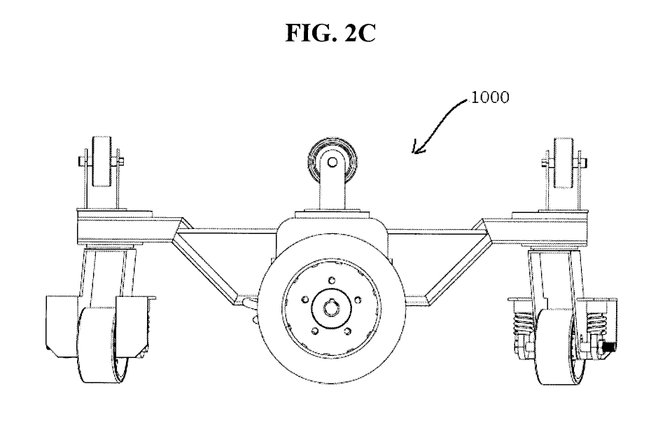

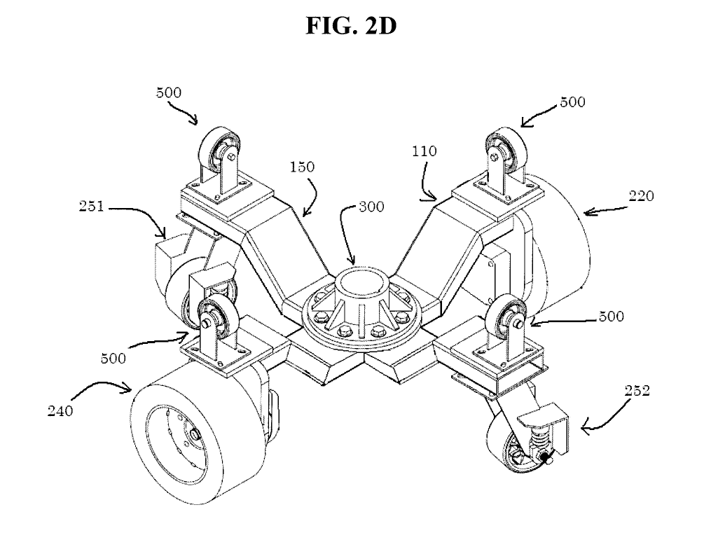

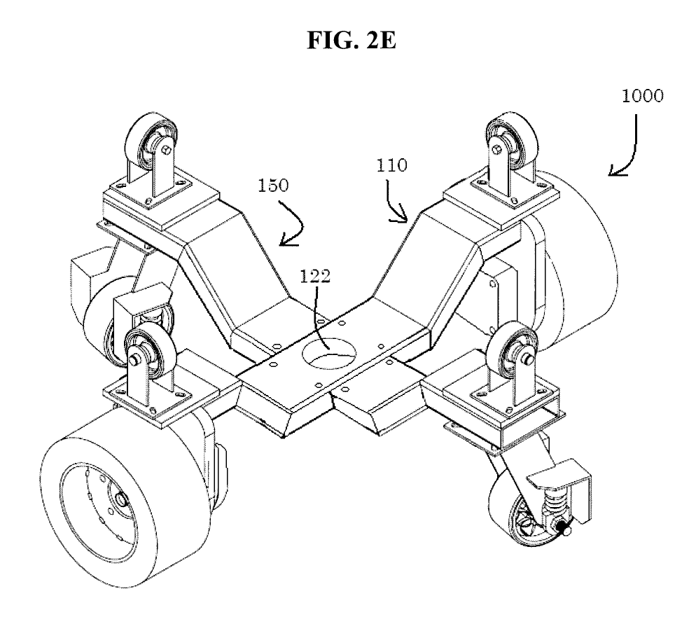

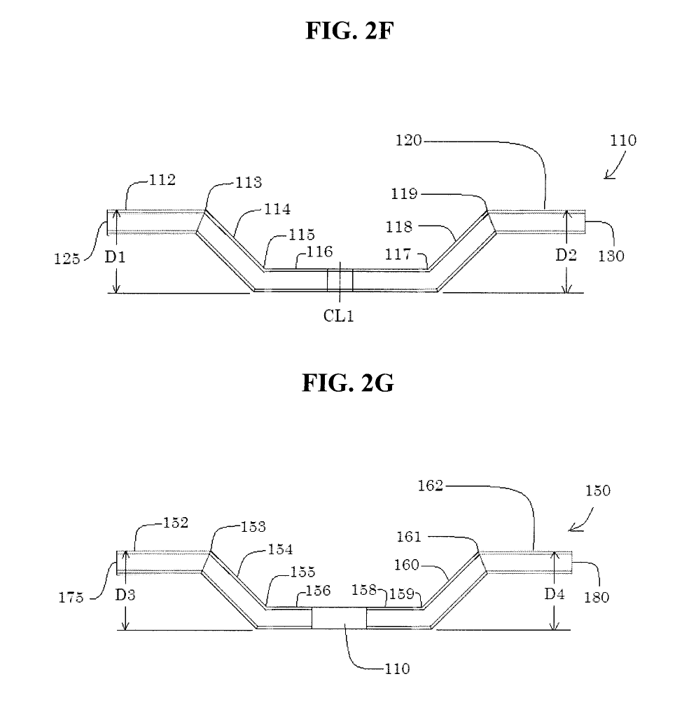

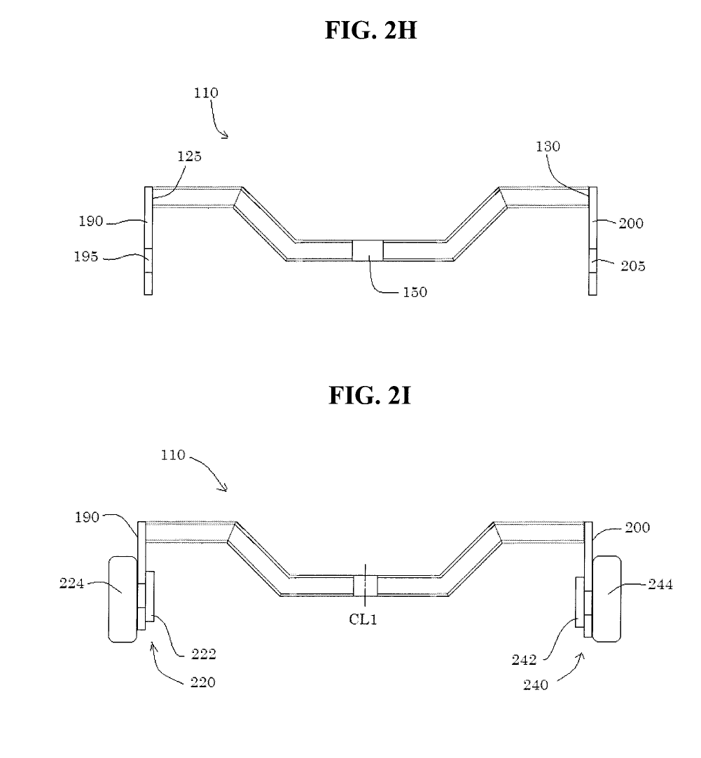

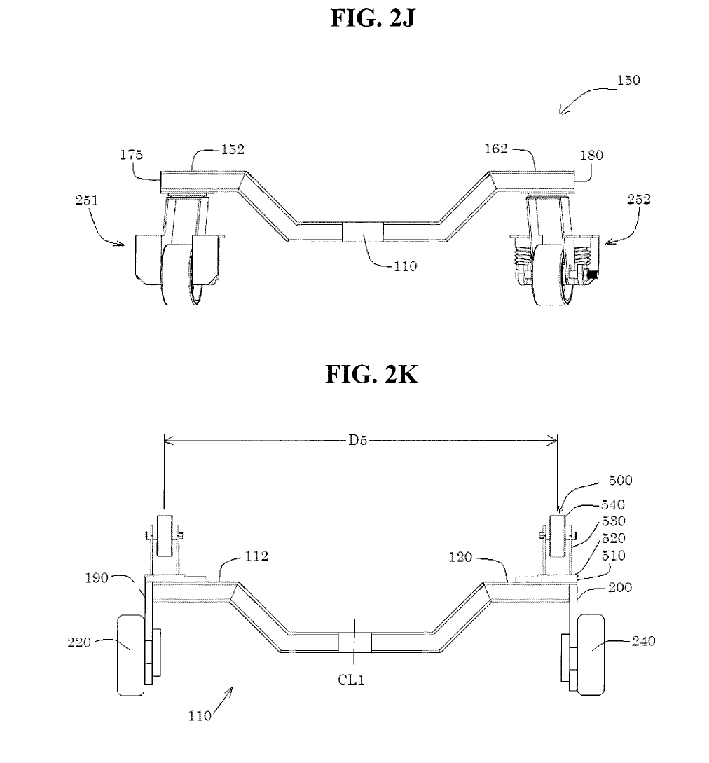

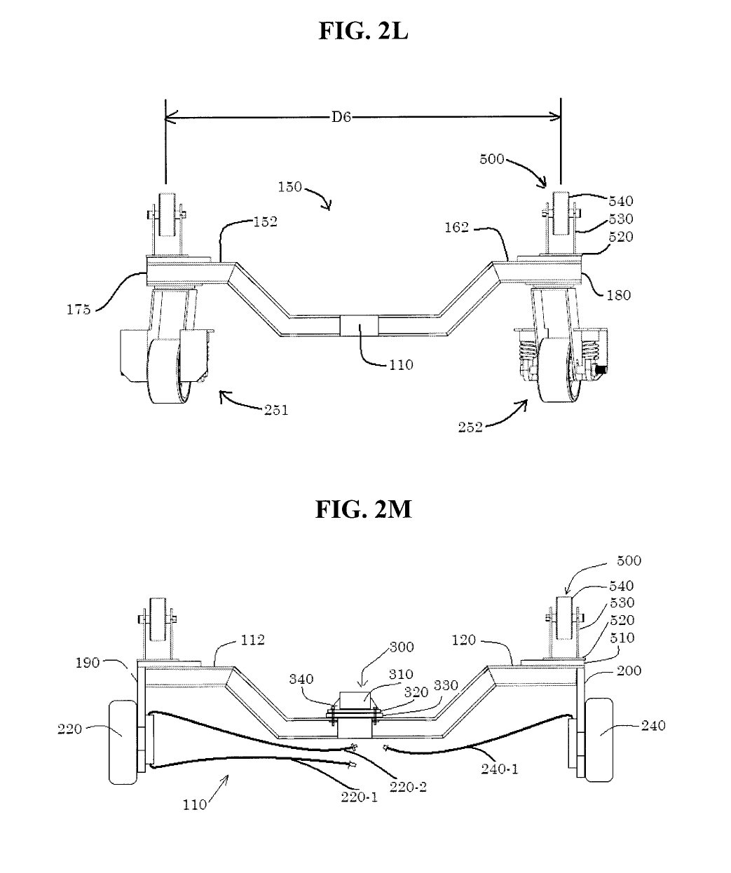

FIGS. 2A-2C illustrate different views of the drive train 1000 in accordance with example embodiments. In particular, FIG. 2A illustrates a perspective view of the drive train 1000, FIG. 2B illustrates a top view of the drive train 1000, and

FIG. 2C illustrates a side view of the drive train 1000. FIGS. 2D and 2E illustrate the drive train 1000 with various components thereof removed in order to better illustrate various features of the drive train 1000. For example, FIG. 2D illustrates the drive train 1000 with reinforcing members 400 and bars 405 (to be explained later) removed in order to better illustrate various aspects of the drive train 1000. FIG. 2E also shows the drive train 1000 with reinforcing members 400 and bars 405 removed there from. However, in FIG. 2E, a base 300 (to be explained later) is also removed to more clearly illustrate features associated with the drive train 1000.

Referring to FIGS. 2A-2C, the example drive train 1000 may include a chassis 105 supported by a drive unit 220, a brake unit 240, and at least one supporting member 250. In example embodiments the drive unit 220 may include a drive wheel 224 operatively connected to a motor 222, the brake unit 240 may include a brake wheel 244 operatively connected to a brake member 242, and the at least one supporting member 250 may be a castor wheel or multiple castor wheels, for example, a pair of castor wheels 251 and 252 as shown in at least FIGS. 2A-2D. Although example embodiments are illustrated as including a drive unit 220, a brake unit 240 and at least one supporting member 250, the invention is not limited thereto. For example, there may be more than one brake unit 240, more than one drive unit 220, and more than two supporting members 250. In addition, the brake unit 240 and the at least one supporting member 250 may be omitted entirely.

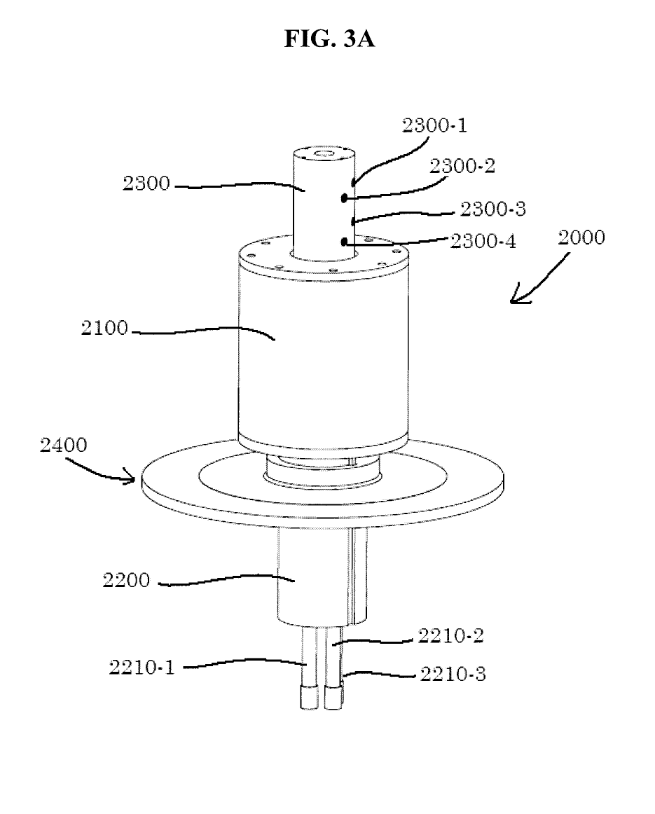

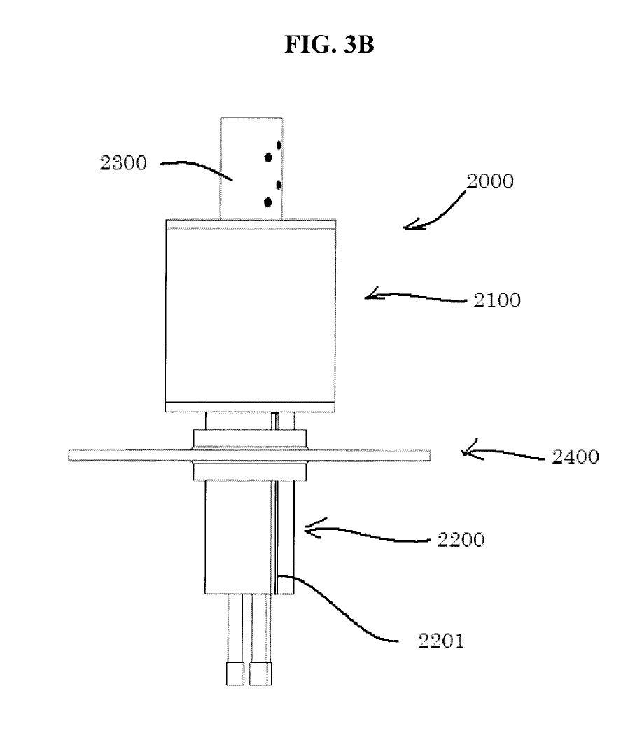

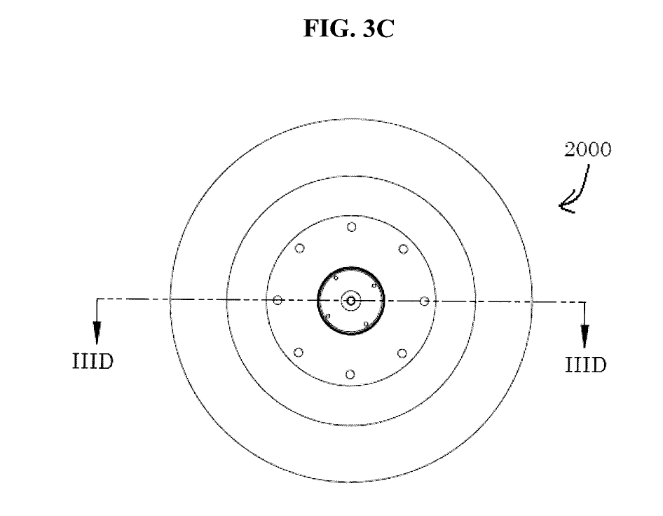

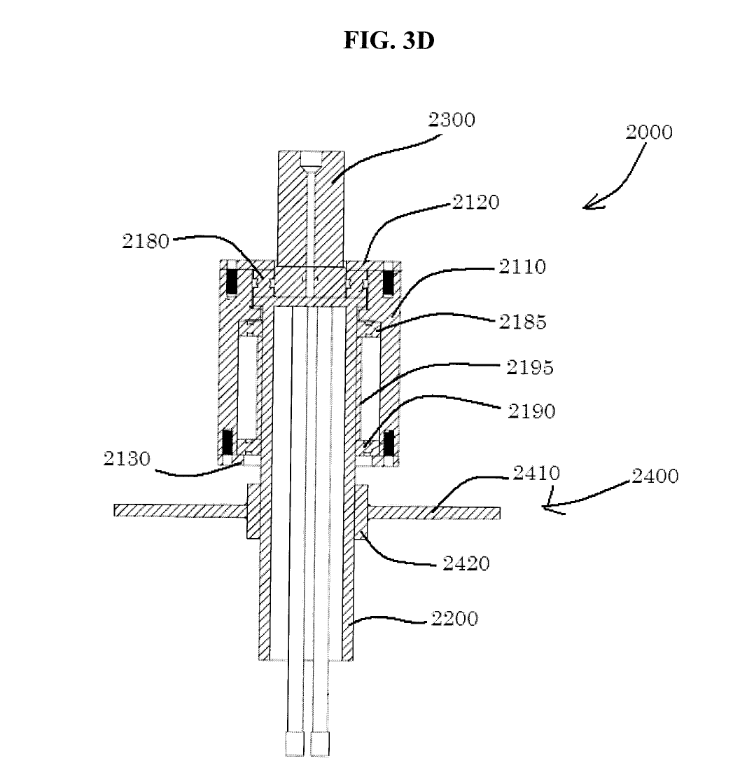

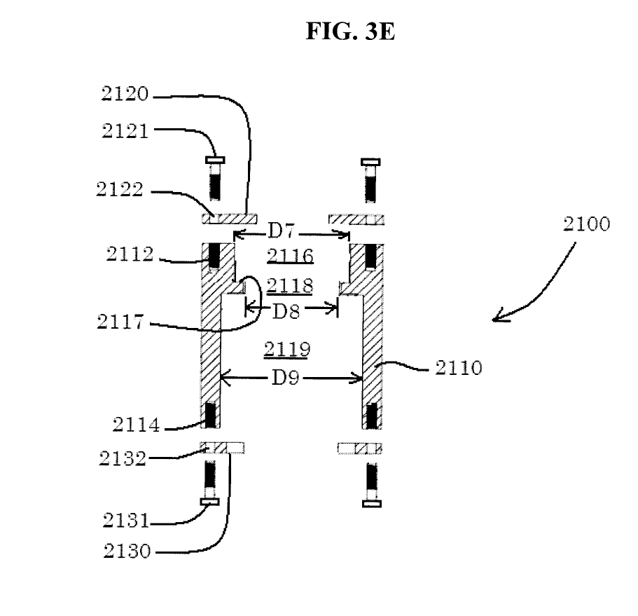

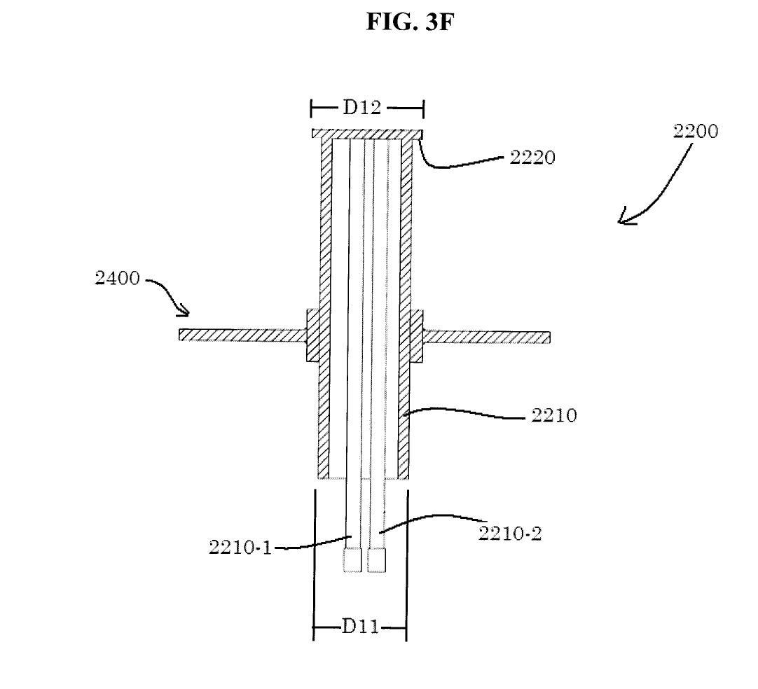

In example embodiments, the drive train 1000 may include a base 300 on the chassis 105. The base 300 may be configured to interface with, and restrain, the pedestal assembly 2000. As shown in the figures, the base 300 may include a hollow member that may be positioned over a hole 122 (see FIG. 2E) that may be present in the chassis 105. For example, as shown in at least FIGS. 2A, 2B, 2D, and 2M, the base 300 may include a center column 310, a first mounting plate 320, a second mounting plate 330, and a plurality of stiffeners 340 reinforcing the center column 310. In example embodiments, the center column 310 may resemble a cylinder having an inside diameter large enough to accommodate an outside diameter of a member (for example, a shaft body 2210 (see FIG. 3F)) of the pedestal assembly 2000. Thus, in example embodiments, a member of the pedestal assembly 2000 may be inserted into the center column 310.

In example embodiments, the center column 310 may have a slot 301 (see FIG. 2A) into which a protruding member (for example, see protrusion 2201 of the shaft body 2210 illustrated in FIG. 3B) of the pedestal assembly 2000 may be inserted. Thus, while a member of the pedestal assembly 2000 may be insertable into the center column 310, the pedestal assembly 2000 may be restrained from rotating within the center column 310. It should be noted that the base 300 illustrated in the figures is exemplary only and is not intended to limit the invention. For example, although the figures illustrate the base 300 as having a cylindrical center column 310 with the slot 301 and the pedestal assembly 2000 having the protrusion 2201 configured to interface with the slot 301, the invention is not limited thereto. For example, in example embodiments the column 310 may alternatively have a protrusion formed along an inside surface thereof and the protrusion may be configured to engage a slot formed in an outside surface of a member of the pedestal assembly 2000 (for example, on an outside surface of the shaft body 2210). As yet another example, the center column 310 may, instead of having an annular cross-section, have a rectangular tube-shaped cross section and an end of the shaft body 2210 may likewise have a rectangular cross-section. In this latter embodiment the shaft body 2210 may still be insertable into the center column 310 but would not be able to rotate therein.

As explained earlier, the base 300 may be positioned over a hole 122 that may be present in the chassis 105. Thus, in example embodiments, various objects, for example, hydraulic, electric, or pneumatic cables, may be inserted through the base 300 and as well as the chassis 105. Thus, in example embodiments, the base 300 may, in addition to serving as a restraining member, also serve as a passageway through which the various objects may pass.

In example embodiments, the base 300 may be connected to the first chassis 105 by bolting as shown in FIG. 2A. However, example embodiments are not limited thereto as the base 300 may be welded to the chassis 105. In the alternative, the base 300 may be clamped or pinned to the chassis 105.

In example embodiments, the chassis 105 may be comprised of a first structural member 110 and a second structural member 150. The first structural member 110, for example, may be a bent tubular member. For example, as shown in FIG. 2F, the first structural member 110 may be tubular member having four bends. The first bend 113 may form a boundary between a first portion 112 of the first structural member 110 and a second portion 114 of the first structural member 110. The first structural member 110 may further include a second bend 115 forming a boundary between the second portion 114 of the first structural member 110 and a third portion 116 of the first structural member 110. The first structural member 110 may further include a third bend 117 forming a boundary between the third portion 116 of the first structural member 110 and a fourth portion 118 of the first structural member 110. The first structural member 110 may further include a fourth bend 119 forming a boundary between the fourth portion 118 of the first structural member 110 and a fifth portion 120 of the first structural member 110.

Although example embodiments illustrate the first structural member 110 as being comprised of a bent tubular member, example embodiments are not limited thereto. For example, the first structural member 110 may be formed of an open member, for example, a beam having an I shaped cross section, a T shaped cross section, an H shaped cross section, a C shaped cross section, or an L shaped cross section. In the alternative, the first structural member 110 may be comprised of both open and tubular members. Furthermore, the first structural member 110 may be comprised of more or less bends as shown in FIG. 3. For example, the first structural member 110 may not include any bends, one bend, two bends, three bends, or more than four bends. In addition, the first structural member 110 may be bent in a manner that protrudes upwards rather than downwards as is shown in the figures. Further yet the first structural member may be formed as a built up member (comprised of cut structural members welded together to form a substantially similar structure as the first structural member 110) and thus may not be one continuous member having various bends.

In example embodiments the first structural member 110 may be substantially symmetrical with respect to a centerline CL₁ passing through a center thereof. Accordingly, a distance D₁ measured from a lower surface of the third portion 116 of the first structural member 110 to an upper surface of the first portion 112 of the first structural member 110 may be substantially the same as a distance D₂ measured from the lower surface of the third portion 116 of the first structural member 110 to an upper surface of the fifth portion 120 of the first structural member 110. However, example embodiments are not limited thereto as D₁ may be different from D₂.

In example embodiments, a hole 122 (see FIG. 2E) may be formed through the first structural member 110. In example embodiments a center of the hole may be coincident with the centerline CL1. As shown in FIG. 2E the hole 122 may be substantially circular, however, example embodiments are not limited thereto as the hole 122 may have another shape, such as an elliptical shape, irregular shape, or polygon shape (such as a triangle, rectangle, square, hexagonal, or octagonal). As was explained earlier, the hole 122 may allow for lines to pass therethrough. For example, hydraulic, pneumatic, or electrical lines connected to the driving and braking units 220 and 240 may pass through the hole 122 and to a power source such as a pump or a current generator.

In example embodiments, the second structural member 150 may be formed to extend from the first structural member 110. The second structural member 150, for example, may be comprised of bent tubular members. For example, as shown in FIG. 2G, the second structural member 150 may be comprised of tubular members having four bends. The first bend 153 may form a boundary between a first portion 152 of the second structural member 150 and a second portion 154 of the second structural member 150. The second structural member 150 may further include a second bend 155 forming a boundary between the second portion 154 of the second structural member 150 and a third portion 156 of the second structural member 150. The second structural member 150 may further include a third bend 159 forming a boundary between a fourth portion 158 of the second structural member 150 and a fifth portion 160 of the second structural member 150. The second structural member 150 may further include a fourth bend 161 forming a boundary between the fifth portion 160 of the second structural member 150 and a sixth portion 162 of the second structural member 150.

In example embodiments, the third portion 156 of the second structural member 150 may attach to the third portion 116 of the first structural member 110 on a first side thereof. Similarly, the fourth portion 158 of the second structural member 150 may attach to a second side of the third portion 116 of the first structural member 110. Furthermore, the third portion 156 and the fourth portion 158 of the second structural member 150 may be substantially perpendicular to the sides of the third portion 116 of the first structural member 110. Thus, when viewed from above, the third portion 156 of the second structural member 150, the fourth portion 158 of the second structural member 150, and the third portion 116 of the first structural member 110 may form a cross when viewed from above. The third and fourth portions 156 and 158 of the second structural member 150 may attach to the first structural member 110 via welding, however, example embodiments are not limited thereto. For example, the third and fourth portions 156 and 158 of the second structural member 150 may attach to the first structural member 110 by bolting or clamping.

In example embodiments the second structural member 150 may be substantially symmetrical. Accordingly, a distance D₃ measured from a lower surface of the third portion 156 of the second structural member 150 to an upper surface of the first portion 152 of the second structural member 150 may be substantially the same as a distance D₄ measured from the lower surface of the third portion 156 of the first structural member 110 to an upper surface of the sixth portion 162 of the second structural member 150. However, example embodiments are not limited thereto as D₃ may be different from D₄. In additions, distances D₁, D₂, D₃, and D₄ may or may not be equal to each other.

Referring to FIGS. 2H and 2I, a first end 125 of the first structural member 110 may be connected to a first connecting member 190, which may, for example, be a plate or a tubular member. Similarly, a second end 130 of the first structural member 110 may connect to a second connecting member 200, which may, for example, be a plate or a tubular member. In example embodiments, the first and second connecting members 190 and 200 may be connected to the first structural member 110 by welding, however, example embodiments are not limited thereto. For example, the first and second connecting members 190 and 200 may be bolted, adhered, or clamped to the first and second ends 125 and 130 of the first structural member 110.

In example embodiments, the drive unit 220 may be connected to the first structural member 110 via the first connecting member 190. For example, the drive unit 220 may be comprised of a drive motor 222, a drive wheel 224, and an axle passing through a first hole 195 that may be formed in the first connecting member 190. In example embodiments, the drive motor 222 may be a conventional electric, pneumatic, or hydraulic motor and may be attached to the first connecting member 190 by a conventional method such as bolting, clamping, pinning or welding. In example embodiments, the drive wheel 224 may be driven by the drive motor 222. Thus, as the drive motor 222 operates, the drive wheel 224 rotates.

In example embodiments, the drive motor 222 may be a reversible motor. Thus, the drive motor 222 may cause the drive wheel 224 to turn either clockwise or counter clockwise depending on how the motor is controlled by an operator. In turning the drive wheel 224 either clockwise or counter clockwise, the dolly may move in at least one direction. Furthermore, although example embodiments illustrate the drive unit 220 as including a drive wheel 224, example embodiments are not limited thereto. For example, rather than being a drive wheel, the drive unit 220 may include a tracked member. For example, rather than including a drive wheel, the drive unit 220 could include of a track type member that includes a belt surrounding and engaging a plurality of wheels or rollers as is commonly seen in a military tank. As another example, the drive unit 220 could employ a plurality of balls (resembling ball bearings) which may be rotated to drive the transport 10.

In example embodiments, the brake unit 240 may be connected to the first structural member 110 via the second connecting member 200. For example, the brake unit 240 may be comprised of a brake member 242, a brake wheel 244, and an axle passing through a second hole 205 that may be formed in the second connecting member 200. In example embodiments, the brake member 242 may be controlled either electrically, pneumatically, or hydraulically and may be attached to the second connecting member 200 by a conventional method such as bolting, clamping, pinning or welding. In example embodiments, the brake wheel 244 may be restrained by the brake member 242. Thus, as the brake member 242 operates, the brake wheel 244 becomes restrained. In example embodiments the brake member 242 may be a hydraulic brake member.

FIG. 2J illustrates the second structural member 150 with the at least one supporting member 250 attached thereto. In example embodiments, the at least one supporting member 250 may be a single castor wheel or may be a plurality of castor wheels arranged below a bottom surface of the second structural member 150. For example, as shown in FIG. 2J, the at least one supporting member 250 may be a pair of castor wheels 251 and 252 attached to an underside of the first portion 152 of the second structural member 150 and an underside of the sixth portion 162 of the second structural member 150. In example embodiments, the pair of castor wheels 251 and 252 may be attached to the first portion 152 and the sixth portion 162 by welding, however, example embodiments are not limited thereto. For example, the castor wheels 251 and 252 may be attached to the first portion 152 and the sixth portion 162 by adhesion, bolting, clamping, or pinning the castor wheels 251 and 252 to the first and sixth portions 152 and 162. Furthermore, the position of the castor wheels 251 and 252 is not limited to being attached to or under the first portion 152 and the sixth portion 162. For example, the castor wheels 251 and 252 could alternatively be attached to the second portion 154, the third portion 156, the fourth portion 158, or the fifth portion 160 or may be attached in a manner than would span various regions of the second structural member 150.

Although example embodiments illustrate the at least one supporting member 250 as a castor wheel, example embodiments are not limited thereto. For example, rather than being a castor wheel, the at least one supporting member 250 could be a tracked member. For example, the at least one supporting member 250 could be comprised of a belt which surrounds and engages a plurality of wheels or rollers. As another example, the at least one supporting member 250 could employ a plurality of balls (resembling ball bearings) which are rotated to support the transport 10.

In example embodiments, a reinforcing member 400, as shown in FIGS. 2A-2C, may be provided to add stability to the drive train 1000 by connecting the first structural member 110 and the second structural member 150 together. In example embodiments, four reinforcing members 400 may be provided to reinforce the drive train 1000, however, example embodiments are not limited thereto as there may be fewer than four reinforcing members 400 provided. In example embodiments, the reinforcing members 400 may be plates, however, example embodiments are not limited thereto. For example, rather than providing reinforcing plates as shown in FIGS. 2A-2C, bars may be provided to attach the first structural member 110 to the second structural member 150. For example, a single bar, or a plurality of bars may be provided in place of each of the reinforcing plates 400 illustrated in FIGS. 1 and 2.

In addition to reinforcing the drive train 1000, the reinforcing plates 400 may also serve as a support point for additional structural members. For example, as shown in FIG. 2A, a bar 405 attached to the second connecting member 200 may also attach to reinforcing member 400 to stabilize and reinforce the drive member 220.

In example embodiments, the first structural member 110, the second structural member 150, and the reinforcing members 400 may be comprised of different and discrete elements which are joined together by a joining process (for example, welding, pinning, adhering, and bolting). However, example embodiments are not limited thereto. For example, the drive train 1000 could be an integrally formed structure produced through a casting process. The casted frame, for example, may have substantially the same form as that produced from the joined first structural member 110, second structural member 150, and reinforcing members 400. In the alternative, a structure resembling a joined first structural member 110 and second structural member 150 may be formed through a casting process and the reinforcing members 400 may be attached thereto by any one of the aforementioned joining processes.

In example embodiments, intermediate supports 500 may be provided between the drive train 1000 and the fixed chassis mount 3000. The intermediate supports 500 may be configured to allow the fixed chassis mount 3000 to rotate relative to the drive train 1000. As shown in FIGS. 2K and 2L, intermediate supports 500 may be placed on the first portion 112 and the fifth portion 120 of the first structural member 110 as well as near a first portion 152 and the sixth portion 162 of the second structural member 150. However, example embodiments are not limited thereto.

In example embodiments, the intermediate supports 500 may be comprised of a roller 540 supported by a couple of substantially parallel plates 530 which are in turn connected to a plate 520. The plate 520 may be directly connected to the drive train 1000 via welding, bolting, or any other mechanism well known in the art. In the alternative, the plate 520 may be connected to an intermediate structure 510 that may be arranged between the plate 520 and the drive train 1000. For example, the intermediate structure 510 may be a plate, for example a shim plate.

Although the intermediate supports 500 have been described as comprising a roller 540 supported by a couple of substantially parallel plates 530, which are in turn connected to a plate 520, example embodiments are not limited thereto. For example, rather than providing the aforementioned structure, the intermediate supports 500 may be structures that comprise bearings. As yet another example, the intermediate supports may be a structure that includes a bearing plate having a very low coefficient of friction or a bearing plate having a lubrication thereon.

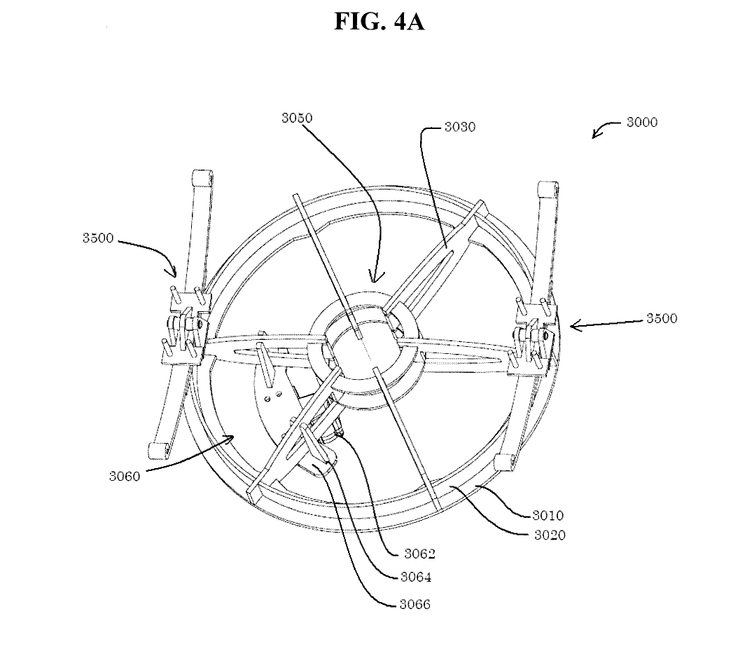

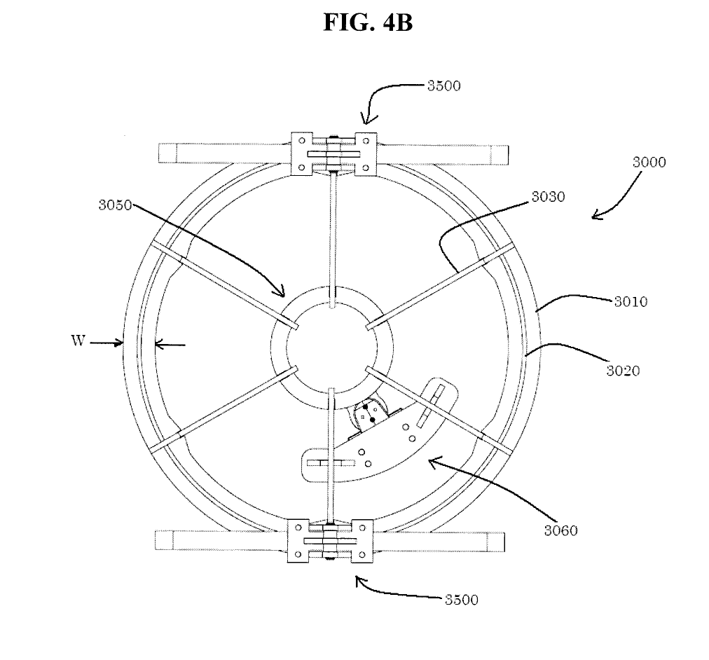

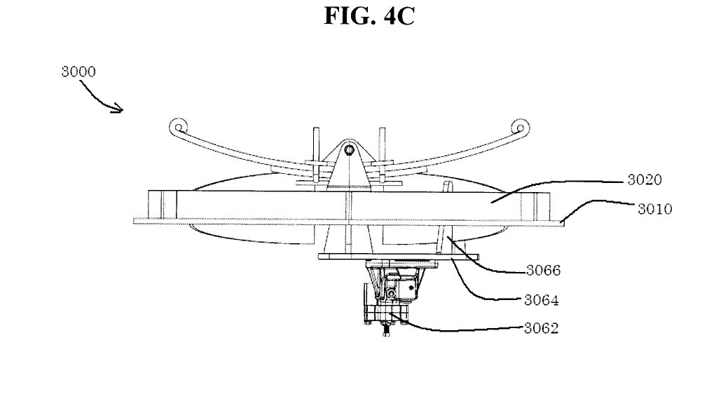

In example embodiments, the fixed chassis mount 3000 may be supported by the intermediate supports 500 as shown in at least FIG. 1. In example embodiments, the fixed chassis mount 3000 may include a track 3010 (see FIG. 4A) configured to interface with the intermediate supports 500. For example, the track 3010 may be a circular member which may be in rolling contact with the intermediate supports 500 when the intermediate supports 500 include a roller. In the alternative, when the intermediate supports 500 includes a low friction plate, or a plate with lubrication thereon, the track 3010 may be in sliding contact with the supports 500.

In example embodiments, the track 3010 may be in contact with each support 500 mounted on the drive train 1000. Thus a diameter of the track 3010 may be about equal to a distance D5 separating the intermediate supports 500 on the first structural member 110 and a distance D6 separating the intermediate supports 500 on the second structural member 150. In example embodiments, the track 3010 may resemble a substantially flat annular disk having a width W (see FIG. 4B) sufficient to accommodate the intermediate supports 500. For example, a width of the track 3010 may be about the same as a width of the intermediate supports 500. Example embodiments, however, are not limited to the aforementioned width W since a width of the track 3010 may be larger or smaller than a width of the intermediate supports 500. Furthermore, example embodiments are not limited to a track 3010 having an annular shape. For example, the track may resemble a circular plate having a polygon shaped area removed from a middle thereof.

In example embodiments, the fixed chassis mount 3000 may include a central axis 3050 which may be connected to the track 3010 via a plurality of ribs 3030. The central axis 3050 may resemble a pair of parallel annular plates which are spaced apart from one another by the ribs 3030. The ribs 3030 may, for their part, resemble substantially triangular shaped plates having a base near the central axis 3050 larger than an apex that may connect to the track 3010 as shown in FIGS. 4A-4C. In example embodiments, the plates forming the central axis 3050 may be oriented horizontally whereas the plates forming the ribs 3030 may be oriented vertically.

In example embodiments, the ribs 3030 may have an end surface that fits entirely on the track 3010, as shown in FIGS. 4A-4C. In example embodiments, the ribs 3030 may or may not include a triangular hole formed therein as shown in FIGS. 4A and 4C. Although the figures illustrate the ribs 3030 as being substantially triangular in shape, example embodiments are not limited thereto. For example, the ribs 3030 may be rectangular in shape.

In example embodiments, a lip 3020 (see FIG. 4A) may be formed on the track 3010. The lip 3020 may resemble an annular cylinder having a relatively short height. In example embodiments, the lip 3020 may be formed on a top surface of the track 3010 and may be formed between ends of the ribs 3030 that are on the track 3010.

In example embodiments, the fixed chassis mount 3000 may include an interfacing unit 3060 which may be configured to interface with the pedestal assembly 2000. In example embodiments, the interfacing unit 3060 may be configured to stop a rotation of the fixed chassis mount 3000 with respect to the drive train 1000. For example, the interfacing unit 3060 may include a caliper 3062 mounted on a brake mount 3064 which may be attached to a couple of ribs 3030 via gusset brake gusset plates 3066. In example embodiments, the brake mount 3064 may resemble a substantially flat plate with a mounting surface large enough attach the caliper 3062 thereto. In example embodiments, the caliper 3062 may be attached to the brake mount 3064 by a conventional method such as bolting and/or welding. Likewise, the brake mount 3064 may be attached to the brake gusset plates 3066 by a conventional method such as welding or bolting. In example embodiments, the brake gusset plates 3066 may likewise be attached to the ribs 3030 by a conventional method such as bolting and/or welding.

As was described earlier, a pedestal assembly 2000 may be provided between the drive train 1000 and the fixed chassis mount 3000. FIGS. 3A-3F provide a nonlimiting example of a pedestal assembly 2000 in accordance with example embodiments. As shown in FIG. 3A, the pedestal assembly 2000 may include a shaft 2200. In example embodiments, the shaft 2200 may include a shaft body 2210 and a cap 2220 (see FIG. 3F). The shaft body 2210, for example, may resemble a hollow cylinder having an outer diameter D11. The cap 2220 may be attached at a first end of the shaft body 2210 and may resemble a circular plate having an outer diameter of D12. In example embodiments, the diameter D12 of the cap 2220 may be slightly larger that the diameter of the shaft body 2210. As shown in FIG. 3F, the shaft body 2210 may partially enclose lines, for example, hydraulic, pneumatic, or electrical lines, that may be connected to hydraulic, pneumatic, or electrical lines of the drive unit 220 and the brake unit 240. As was explained earlier, the shaft 2200 may be inserted into and restrained by the base 300 of the drive train 1000.

In the figures, the shaft body 2210 is shown enclosing three lines 2210-1, 2210-2, and 2210-3. The three lines 2210-1, 2210-2, and 2210-3 may be hydraulic lines that may provide hydraulic fluid to the brake unit 240 and the drive unit 220. For example, in the assembled condition, a first hydraulic line 220-1 (see FIG. 2M) connected to the drive unit 220 may be connected to the first line 2210-1 of the shaft body 2210, a second hydraulic line 220-2 connected to the drive unit 220 may be connected to the second line 2210-2 of the shaft body 2210, and a third hydraulic line 240-1 connected to the brake unit 240 may be connected to the third line 2210-3 of the shaft body 2210.

In example embodiments, the pedestal assembly 2000 may further include a pedestal housing 2100 that may be configured to rotatably support the shaft 2200. In example embodiments, the pedestal housing 2100 may include a pedestal housing body 2110 (see FIG. 3E), a first cap 2120, and a second cap 2130. In example embodiments, the pedestal housing body 2110 may resemble a hollow cylinder having regions with various inside diameters. For example, as shown in FIG. 3E, the pedestal housing body 2110 may have a first region 2116 which has a first diameter D7, a second region 2118 having a second diameter D8, and a third region 2119 having a third diameter D9. In example embodiments, the second diameter D8 may be smaller than the first diameter D7. Thus, in example embodiments, a shoulder 2117 may be formed in the pedestal housing body 2110 at the interface between the first region 2116 and the second region 2118. In example embodiments, the shoulder 2117 may provide a bearing surface onto which a surface of the cap 2220 may bear.

In example embodiments, the diameter D9 of the third region 2119 may be larger than either the diameter D7 of the first region 2116 and the diameter D8 of the second region 2118. In example embodiments, the shaft body 2210 of the shaft 2200 may extend through the third region 2119. In example embodiments, first and second bearings 2185 and 2190, separated by a spacer 2195, may be provided in the third region 2119. The first and second bearings 2185 and 2190 may provide lateral support to the shaft 2200 while allowing the shaft 2200 to rotate freely within the pedestal housing 2100. In example embodiments, the first and second bearings 2185 and 2190 may be roller bearings as are well known in the art.

In example embodiments, a first cap 2120 may be provided at a first end of the pedestal housing 2100 and a second cap 2130 may be provided at a second end of the pedestal housing 2100. In example embodiments, the first cap 2120 may be attached to the pedestal housing 2100 by a first plurality bolts 2121 which may be configured to engage threaded holes 2112 that may be provided near the first end of the pedestal housing. Similarly, the second cap 2130 may be attached to the pedestal housing 2100 by a second plurality of bolts 2131 which may be configured to engage threaded holes 2114 provided near a second end of the pedestal housing 2100. In example embodiments, the first plurality of bolts 2121 may pass through a first plurality of holes 2122 provided in the first cap 2120 and the second plurality of bolts 2131 may pass through a second plurality of holes 2132 that may be provided in the second cap 2130.

In example embodiments, a thrust bearing 2180 may be provided in the first region 2116 of the pedestal housing 2100. The thrust bearing 2180 may be arranged between the cap 2220 of the shaft 2200 and the first cap 2120 of the pedestal housing 2100 to reduce friction between the shaft 2200 and the pedestal housing 2100.

In example embodiments, the pedestal assembly 2000 may include an engaging structure 2400 (an example of an engaging member) which may be configured to engage the interfacing unit 3060 of the fixed chassis mount 3000. For example, the engaging structure 2400 may be comprised of a brake disk 2410 which may be attached to the shaft 2200 via a collar 2420. The collar 2420, for example, may resemble a cylinder having an inner diameter slightly larger than an outer diameter of the shaft 2200. In example embodiments the collar 2420 and the shaft 2200 may be attached to each other by a conventional means such as bolting, pinning, clamping, or welding. Although example embodiments illustrate the brake disk 2410 as being attached to the shaft 2200 via a collar 2420, example embodiments are not limited thereto as the brake disk 2410 may be directly attached to the shaft 2200.

In example embodiments, the pedestal housing body 2110 may be attached to the fixed chassis mount 3000. For example, the outside of the pedestal housing body 2110 may be welded to the plurality of ribs 3030. Thus, the pedestal assembly 2000 may be secured to the fixed chassis mount 3000.

In example embodiments, the pedestal assembly 2000 may further include a rotary manifold 2300. For example, the rotary manifold 2300 may be a hydraulic rotary manifold configured to serve as a conduit through which hydraulic fluid may travel. For example, the rotary manifold 2300 may be a hydraulic rotary manifold that includes four openings 2300-1, 2300-2, 2300-3, and 2300-4 to which hydraulic hoses may attach. In this example, the rotary manifold 2300 may provide hydraulic fluid to the lines 2210-1, 2210-2, and 2210-3 enclosed by the shaft body 2210. As hydraulic rotary manifolds are well know, a description thereof is omitted for the sake of brevity. The invention, however, is not limited to hydraulic manifolds. For example, the rotary manifold 2300 may be an electrical swivel joint which may be configured to provide current to the lines 2210-1, 2210-2, and 2210-3 enclosed by the shaft body 2210.

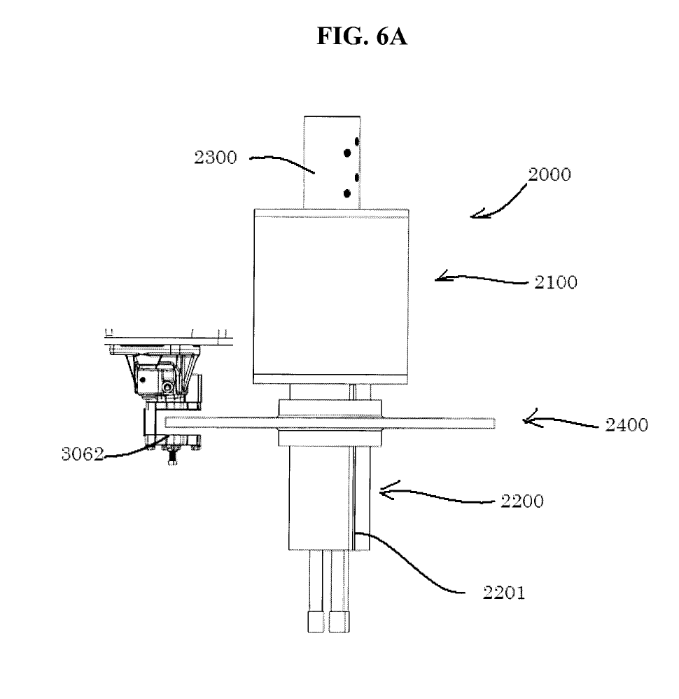

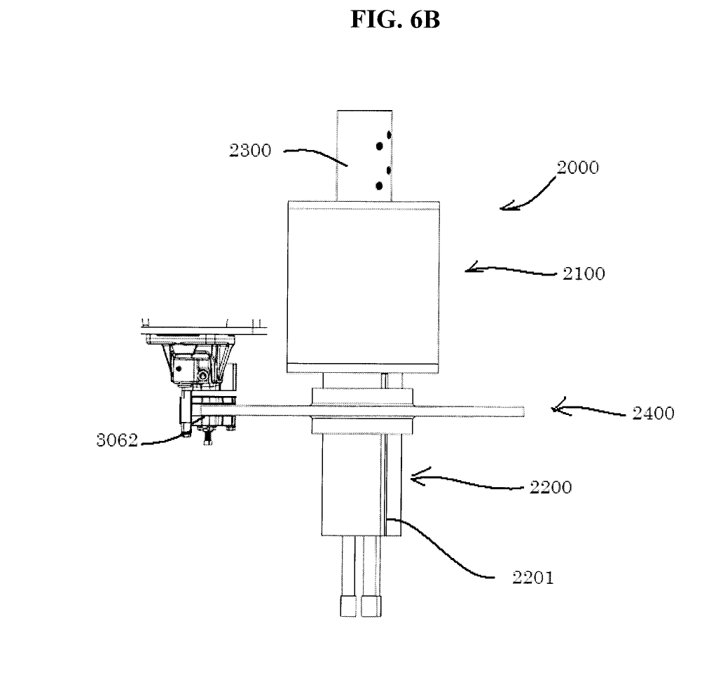

In example embodiments, the interfacing unit 3060 of the fixed chassis mount 3000 and the engaging structure 2400 of the pedestal assembly 2000 may cooperate with each other to prevent the fixed chassis mount 3000 from rotating with respect to the drive train 1000. For example, FIGS. 6A and 6B represent an example of transport 10 wherein the interfacing unit 3060 of the fixed chassis mount 3000 includes a caliper 3062 and the engaging structure 2400 of the pedestal assembly 2000 includes a brake disk. In FIG. 6A, for example, the caliper 3062 is illustrated in an open position where brake pads of the caliper are not engaged with the brake disk. In this position, the fixed chassis mount 3000 is free to rotate with respect to the drive train 1000. FIG. 6B, on the otherhand, illustrates an position where the caliper 3062 is operated so that the brake pads of the caliper are engaged with the brake disk. In this position, the engaged caliper 3062 and brake disk prevent the fixed chassis mount 3000 from rotating with respect to the drive train 1000.

In example embodiments the fixed chassis mount 3000 may include at least one securing structure 3500. The at least one securing structure 3500 may be configured to secure an object to the transport 10. For example, the securing structure 3500 may be a clamp. In example embodiments, two securing structures 3500 may be provided, however, example embodiments are not limited thereto as there may be only a single securing structure 3500 or more that two securing structures 3500.

In example embodiments, the securing structure 3500 may be rigidly connected to the fixed chassis mount 3000 or may be pinned to the fixed chassis mount 3000. In this latter case, a base of the securing structure 3000 would move with the fixed chassis mount 3000, however, the securing structure 3000 would still be rotate about its own base.

In example embodiments, the transport 10 may be used to move a relatively long object, for example, a windmill blade. The transport 10, for example, may be used alone or in a pair. For example, when a pair of transports 10 is used, one of the pair of transports 10 may be arranged at one end of the relatively long object while the other of the pair of transports 10 may be placed at another end of the relatively long object.

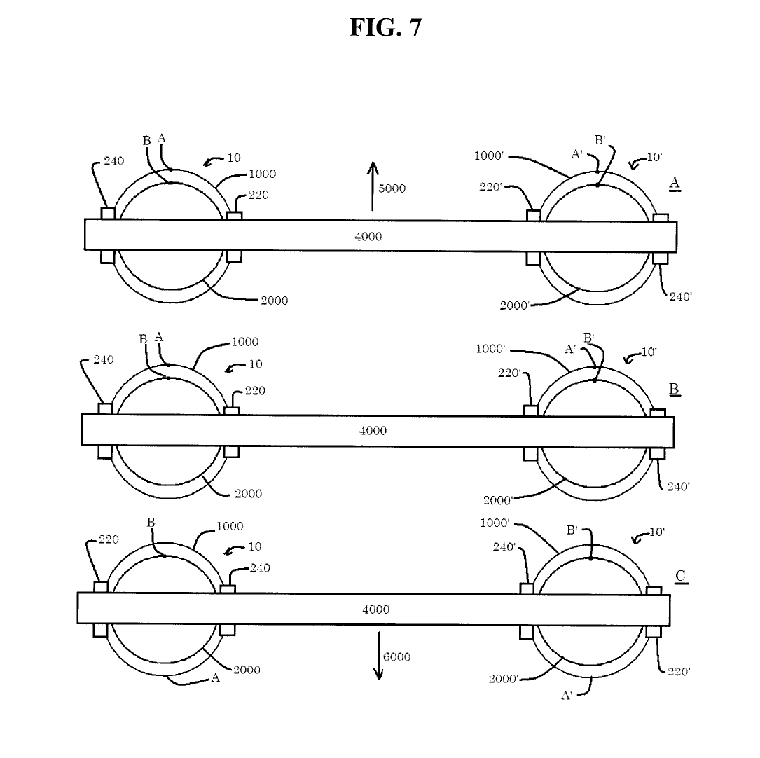

FIG. 7 is an example of the described motion. In FIG. 7, a load 4000 may be supported by a first transport 10 and a second transport 10′ at two different ends of the load 4000. The second transport 10′ may be substantially identical to the first transport 10, thus, a detailed description thereof is not presented for the sake of brevity.

In FIG. 7, the load 4000 may be moved in a first direction 5000 (see position A) by actuation of the drive units 220 and 220′. However, if it is desired to move the load 4000 in a second direction 6000 which is 180° from the first direction 5000, the driving units 220 and 220′ may be stopped as shown in position B of FIG. 7. The calipers 3062 of each of the first and second transports 10 and 10′ may be disengaged. Thus, subsequent operation of the drive members 220 and 220′ cause the drive trains 1000 and 1000′ of the first and second transports 10 and 10′ to rotate to the position shown in position C of FIG. 13. In position C the calipers 3062 may then be reengaged. Subsequent operation of the driving members 220 and 220′ would cause the load to move in the second direction 6000.

As is obvious from the above disclosure, the dolly 10 may be implemented hydraulically, electrically, and/or pneumatically. For example, in the event the dolly 10 is implemented hydraulically, hydraulic hoses may be attached to the rotary manifold 2300. For example three hydraulic hoses may be attached to the rotary manifold at openings 2300-1, 2300-2, and 2300-3. The first opening may allow hydraulic fluid to flow through the rotary manifold and to a first hydraulic hose 2210-1 which is enclosed by the shaft body 2210. The hydraulic fluid passing through the first hydraulic hose 2210-1 may connect to a hydraulic hose 220-1 that is connected to the drive motor 220 (which may be a hydraulic motor). The hydraulic fluid may flow through and exit the drive motor 220 via another hydraulic hose 220-2 which may be connected to a second hydraulic hose 2210-2 enclosed by the shaft body 2210. The second hydraulic hose 2210-2 may also be connected to the rotary manifold 2300, thus, the return hydraulic fluid may enter the rotary manifold 2300 via the second hydraulic hose 2210-2. Thus, the drive motor 220 may be operated via hydraulic fluid flowing through the rotary manifold. Similarly, the brake unit 240 may include a hydraulic brake which may receive hydraulic fluid through a third hydraulic hose 2210-3 enclosed by the shaft body 2210. The third hydraulic hose 2210-3 may, in addition to being connected to the rotary manifold 2300, be connected to a hydraulic hose 240-1 which is connected to the brake member 242. Thus, the brake member 242 may be in fluid communication with the rotary manifold via the third hydraulic hose 2210-3 and the hydraulic hose 240-1.

Example embodiments may be implemented using conventional components arranged and operated in a novel manner. For example, a rotary manifold usable with example embodiments is produced by Rotary systems (more specifically, rotary union model number 016-N-4221-BT). A motor usable as motor 222 may be an Eaton wheel motor model 162-1024-004. A hydraulic brake usable as hydraulic brake member 242 may be mico corporation hydraulic brake model number 13-587-024. A caliper usable as the caliper 3062 may be a mico corporation brake caliper, model number 02-530-628.

In example embodiments, variations of the aforementioned dolly 10 are considered to fall within the scope of the invention. For example, the dolly 10 has been illustrated as including a drive unit 220 and a brake unit 240. In example embodiments, however, the brake unit 240 may be replaced by a drive unit which may be substantially identical to the previously described drive unit 220. Thus, in example embodiments, a motor may be substituted for the brake member 242 to drive the wheel 244. The additional motor may be substantially identical to the motor 222 and thus may be a reversible motor. In example embodiments, the motor 222 and the additional motor may be operated simultaneously to create a force couple thus providing greater flexibility in controlling the dolly 10 (for example, by causing the dolly to rotate under the influence of the motor 222 and the additional motor). In addition, the motor 222 and the additional motor may be operated together to provide additional power to drive the dolly 10 in a desired direction.

In the event the brake unit 240 is replaced by a drive unit, the modified dolly 10 may be implemented hydraulically, electrically, and/or pneumatically. For example, in the event the modified dolly 10 is implemented hydraulically, hydraulic hoses may be attached to the rotary manifold 2300. For example four hydraulic hoses may be attached to the rotary manifold at openings 2300-1, 2300-2, 2300-3, and 2300-4. The first opening 2300-1 may allow hydraulic fluid to flow through the rotary manifold 2300 and to a first hydraulic hose 2210-1 which is enclosed by the shaft body 2210. The hydraulic fluid passing through the first hydraulic hose 2210-1 may connect to a hydraulic hose 220-1 that is connected to the drive motor 220 (which may be a hydraulic motor). The hydraulic fluid may flow through and exit the drive motor 220 via another hydraulic hose 220-2 which may be connected to a second hydraulic hose 2210-2 enclosed by the shaft body 2210. The second hydraulic hose 2210-2 may also be connected to the rotary manifold 2300, thus, the return hydraulic fluid may enter the rotary manifold 2300 via the second hydraulic hose 2210-2. Thus, the drive motor 220 may be operated via hydraulic fluid flowing through the rotary manifold. Similarly, the additional drive unit may include a hydraulic motor which may receive hydraulic fluid through a third hydraulic hose 2210-3 enclosed by the shaft body 2210 (noting that the third hydraulic hose 2210-3 is in fluid communication with the rotary manifold 2300). The third hydraulic hose 2210-3 may, in addition to being connected to the rotary manifold 2300, be connected to a hydraulic hose 240-1 which may be connected to the additional motor. Thus, the additional motor may be in fluid communication with the rotary manifold via the third hydraulic hose 2210-3 and the hydraulic hose 240-1. Hydraulic fluid may be returned from the additional motor to the rotary manifold 2300 by a fourth hose (not shown) which is connected to the additional motor and in fluid communication with the rotary manifold. In example embodiments, the fourth hose may be partially enclosed by the shaft body 2210. The fourth hose may be in fluid communication with the fourth hole 2300-4 of the hydraulic manifold 2300.

While example embodiments have been particularly shown and described with reference to example embodiments thereof, it will be understood by those of ordinary skill in the art that various changes in form and details may be made therein without departing from the spirit and scope of the invention.

What is claimed:

1. A transport comprising:
a drive train;
a fixed chassis mount on the drive train; and
a pedestal assembly between the drive train and the fixed chassis mount, wherein the fixed chassis mount is configured to rotate on the drive train.

2. The transport according to claim 1, wherein the drive train includes a drive unit configured to move the transport in at least one direction.

3. The transport according to claim 2, wherein the drive unit includes a drive motor and a drive wheel.

4. The transport according to claim 1, wherein the drive train includes a chassis and at least one intermediate support between the chassis and the fixed chassis mount.

5. The transport according to claim 1, wherein
the drive train includes a base into which an element of the pedestal assembly is inserted.

6. The transport according to claim 5, wherein the base is configured to prevent the element of the pedestal assembly from rotating.

7. The transport according to claim 1 wherein the fixed chassis mount includes an interfacing unit configured to engage an engaging member of the pedestal assembly such that when the interfacing unit and the engaging member are engaged, the fixed chassis mount is restricted from rotating on the drive train.

8. The transport according to claim 7, wherein the interfacing unit includes a caliper and the engaging member includes a brake disk.

9. The transport according to claim 8, wherein the pedestal assembly includes a pedestal housing body enclosing a shaft.

10. The transport according to claim 9, wherein the pedestal housing body is attached to the fixed chassis mount and the brake disk is attached to the shaft.

11. The transport according to claim 10, wherein the fixed chassis mount includes a track supported by the drive train, a central axis connected to the track by a plurality of ribs, and the pedestal housing body is attached to at least one of the plurality of ribs and the central axis.

12. The transport according to claim 11, wherein
the drive train includes a chassis and at least one intermediate support on the chassis, the at least one intermediate support supporting the track.

13. The transport according to claim 12, wherein the drive train further includes a base on the chassis and the shaft is inserted into the base.

14. The transport according to claim 13, wherein the base is configured to restrict a rotation of the shaft.

15. The transport according to claim 1, wherein the fixed chassis mount includes a securing structure configured to support an external load.
